(19) United States
(12) Patent Application Publication
(10) Pub. No.: US 2011/0060745 A1
(43) Pub. Date: Mar. 10, 2011

(54) Method and system for configurable index generation and application

(76) Inventor: Leonard Hoffman, Minneapolis, MN (US)

(21) Appl. No.: 12/584,477

(22) Filed: Sep. 4, 2009

(51) Int. Cl. G06F 17/30

(52) U.S. Cl. 707/748; 707/E17.005

(57) ABSTRACT

A method system and computer having a database management system to apply a user-provided index authored by a programmer, wherein the user-provided index is accepted by the computer and the database management system applies the user-provided index and the user authored index descriptor in database searches. A user may select, generate, and direct the computer to generate, or input an index descriptor, or information used by the computer to populate an index descriptor. The computer may examine the index descriptor in response to receipt or generation of a search query, and determine a relevance of the user-provided index for use in processing the query. The database management system may include a plurality of indexes, and the computer may evaluate the index descriptor to determine a relevance of the user provided index relative to the plurality of indexes. The computer may optionally apply a sequence of indexes in processing a search.

### BACKGROUND OF THE INVENTION

1. Technical Field

The present invention generally relates to method and systems for selecting information from information technology systems. The present invention more particularly relates to a method and system for applying indexes in search queries of databases stored within or accessible to information technology systems.

2. Background Art

The prior art includes information technology systems that use database management systems to enable searches of gigabytes and more of digitally stored data. Many prior art database management systems apply search indexes that are generated by a system architect or are created as a result of searches performed by the data base management system. In particular, data base management system providers often include search indexes as a component of a delivered product and optionally as a customization service providing to customers or licensees during an installation phase or under a maintenance agreement.

Users of certain information technology systems may generate their own search indexes. The prior art, however, does not provide an optimized system or method to enable an inclusion of a user generated, or user acquired, search index for selection by an information technology system from a plurality of search indexes as provided by, or accessible to, a data base management system.

There is, therefore, a long-felt need to enable a user of a database management system of an information technology system to provide search indexes to the information technology system that can be selected for use in searching one or more databases.

### SUMMARY OF THE INVENTION

This and other objects of the present invention are made obvious in light of this disclosure, wherein methods, systems and computer program products are provided for directing a computational device (hereinafter, “computer”) having a database management system to apply a user-provided index, wherein the user-provided index and an index descriptor is accepted by the computer. The index descriptor is populated and organized in accordance with the direction of a human being (“hereinafter, “the programmer”) and the database management system applies the index descriptor and the user-provided index in database searches. The computer examines the index type descriptor to determine a relevancy of the index described by the index descriptor for use in executing a search process with a particular query.

According to one alternate aspect of the method of the present invention, the programmer may select, generate, and direct a computer to form, populate and/or input the index descriptor, or information used by the computer to populate an index descriptor. The computer may examine the index descriptor in response to a receipt or a generation of a search query, wherein the computer may determine a relevance of the user-provided index for use in processing the query on the basis of information and structure of the index descriptor as created according to the previous programmer's direction to the computer. The index descriptor may be generated on a first computer and by the programmer then transferred as a completed or partial index descriptor to one or more additional computers.

The database management system may include a plurality of indexes, and the computer may evaluate the index descriptor to determine a relevance of the associated user provided index relative to the plurality of indexes. The computer may optionally apply a sequence of indexes in processing a search.

According to various aspects of the method of the present invention, the index descriptor authored by the programmer may indicate that (1.) a certain, some or all key attributes of the user-provided index required by the computer to apply the user provided index in the search; (2.) a key of the user provided index; and/or (3.) a plurality of key attributes of the user provided index are ordered.

According to other various aspects of the method of the present invention, the index descriptor may denotes one or more characteristics of the user-provided index, such as (1.) a fixed record size of a record; (2.) an ordered collection; (3.) that duplicate records are allowed; (3.) that iteration is supported; (4.) that keyed access is supported; (5.) range access is supported.

According to still other various aspects of the method of the present invention, the index descriptor may include a collection type descriptor that specifies a collection characteristic, e.g., a key type descriptor.

According to alternate aspects of the method of the present invention, a computer system is provided that includes one or more processors; an input module, a memory coupled with at least one processor and the input module, a display module coupled; and a process for accepting and applying user-provided indexes. One or more user-provided indexes may be received by the computer from an electronic medium via an electronic medium reader and/or input through the input module.

According to alternate aspects of the method of the present invention, a computer program product is provided that includes a computer operable medium having computer readable code that may direct a computer to accept and apply a user-provided index.

The foregoing and other objects, features and advantages will be apparent from the following description of aspects of the present invention as illustrated in the accompanying drawings.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

U.S. Pat. No. 7,523,096 (Inventors: Badros, et al.; issued on Apr. 21, 2009) titled “Methods and systems for personalized network searching”; U.S. Pat. No. 7,509,252 (Inventors: Cencini, et al.; issued on Mar. 24, 2009) titled “Full-text index module consistency checking”; U.S. Pat. No. 7,454,398 (Inventors: Kehlenbeck, et al.; issued on Nov. 18, 2008) titled “Support for object search”; U.S. Pat. No. 7,162,473 (Inventors: Dumais, et al.; issued on Jan. 9, 2007) titled “Method and system for usage analyzer that determines user accessed sources, indexes data subsets, and associated metadata, processing implicit queries based on potential interest to users”; U.S. Pat. No. 7,444,343 (Inventors: Wang, et al.; issued on Oct. 28, 2008) titled “Hybrid location and keyword index”; U.S. Pat. No. 7,031,961 (Inventors: Pitkow, et al.; issued on Apr. 18, 2006) titled “System and method for searching and recommending objects from a categorically organized information repository”; U.S. Pat. No. 7,107,264 (Inventor: Lu, Q.; issued on Sep. 12, 2006) titled “Content bridge for associating host content and guest content wherein guest content is determined by search”; and U.S. Pat. No. 6,801,904 (Inventors: Chaudhuri, et al.; issued on Oct. 5, 2004) issued on “System for keyword based searching over relational databases” are each incorporated herein by reference in their entirety and for all purposes.

In addition, United States Patent Application Publication No. 20080215553 (Inventors: Badros, et al.; published on Sep. 4, 2008) titled Personalized Network Searching”; and United States Patent Application Publication No. 20090100022 (Inventors: Nayak, et al.; published on Apr. 16, 2009) and titled “INTEGRATED FULL TEXT SEARCH SYSTEM AND METHOD” are each incorporated herein by reference in their entirety and for all purposes.

All publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 illustrates a prior art process, wherein an index is selected for use in a search by a query engine of a computer and an index descriptor as authored by a programmer is accepted by the computer;

FIG. 2 illustrates a first method in accordance with a first aspect of the method of the present invention, wherein user provided index is provided and selected for use in a search by a query engine;

FIG. 3 is a schematic diagram of a computer that may comprise the query engine and the user provided index of FIG. 2;

FIG. 4 is a schematic diagram of a system software of the computer 3;

FIG. 5 is a schematic diagram of an electronics communications network referenced in FIGS. 2 and 4;

FIG. 6 is an illustration of qualities of an index of FIGS. 2 and 4 that may be denoted within a programmer authored index type descriptor of FIGS. 4 and 5; and

FIG. 7 is a schematic of an exemplary index type descriptor of FIGS. 4 and 6; and

FIG. 8 illustrates a third aspect of the method of the present invention, wherein the data base management system of FIGS. 3 and 4 acquires an index of FIG. 4 for selection for use in handling an specific search process.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

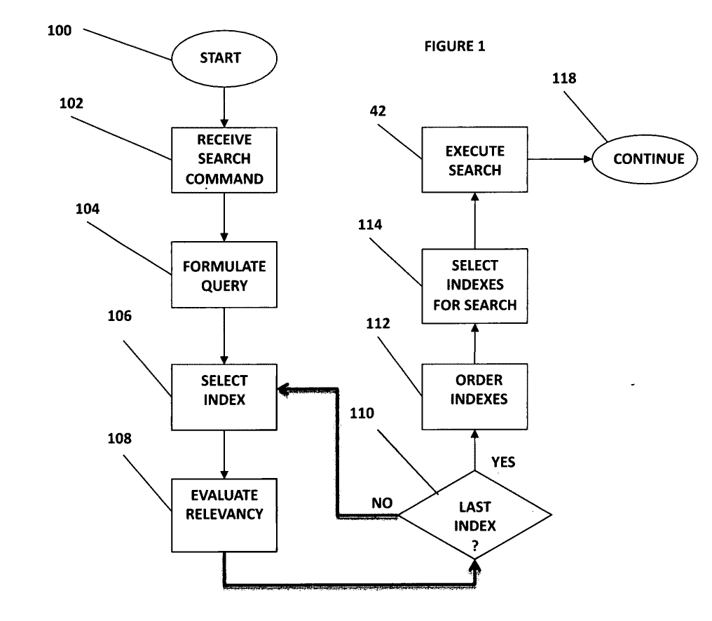

Referring now to FIG. 1, FIG. 1 illustrates a prior art process, wherein an index 2 is selected for use in a search by a query engine 4. In step 102 an information technology system 6, or “computer” 6, receives a search command either as an input from a user or via an electronic communications network 8. In step 104 a data base management system 10 of the computer 6 interprets the search command into a query that can be executed by the query engine 4. The computer 6 then cycles through step 106-110 and selects and evaluates one or more indexes 2 maintained by, or accessible to, the data base management system 10 (hereinafter “DBMS” 10). The computer 6 may then optionally order the indexes 2 from most relevant to least relevant in step 112, and then select one, several, or all of the indexes 2 for use in fulfilling the search command received in step 102. The computer 6 then executes a search in step 116 by processing the query formulated in step 104 and applying the indexes 2 selected in step 114 and in order of most relevant index 2 to least relevant index 2 of the selected indexes 2 of step 114.

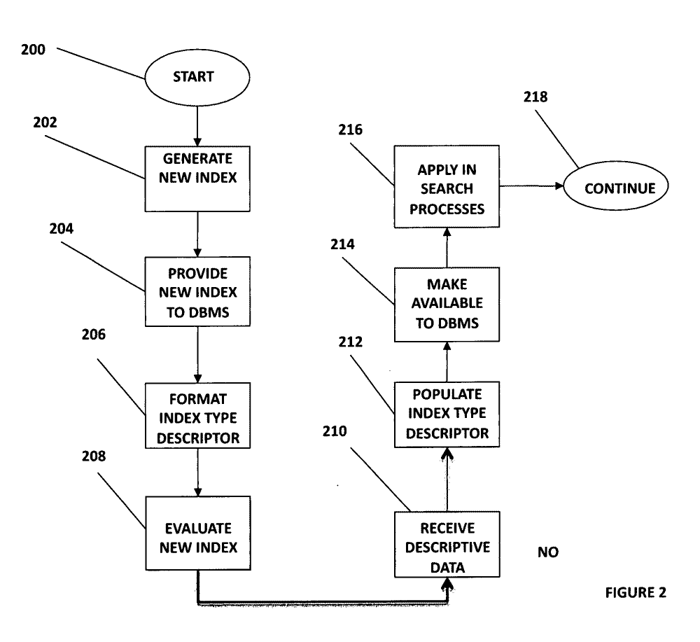

Referring now generally to the Figures and particularly to FIG. 2, FIG. 2 illustrates a first method in accordance with a first aspect of the method of the present invention, wherein a user provided index 12 is provided and selected for use in a search by the query engine 4.

In step 202 the user provided index 12 is input into the computer 6. This index generation may occur in the process of a search conducted by the query engine 4 of the DBMS 8 of the computer 6, or may be generated by means of a second computer 14. The user provided index 12 (hereinafter “new index” 12) is provided to the DBMS 8 of the computer 6 in step 204, wherein the computer 6 may receive the new index 12 (a.) by generation by the computer 6, (b.) by transmission via the electronics communications network 8; or (c.) by up loading from an electronic media 14. The programmer generates a new index type descriptor 16 by inputting data and formatting selections into the computer 6 in step 206 and the computer 6 evaluates the new index 12 in optional step 208. The computer 6 receives descriptive data regarding the new index 12 from the programmer in step 210 and populates the new index type descriptor 16 in step 212 with data received from the programmer in step 210 and optionally with descriptive information derived by the computer 6 in the evaluation of step 208.

It is understood that the descriptive data received in step 210 may be received, in whole or in part, from one source or from a combination of sources, (a.) from a programmer to the computer 6; (b.) by generation by the computer 6; (c.) by transmission via the electronics communications network 8; or (d.) by up loading from the electronic media 14.

The new index 12 and the new index type descriptor 16 are made available to the DBMS 8, and in step 216 the new index 12 and the new index type descriptor 18 are applied, as determined by the DBMS 8, in database search processes.

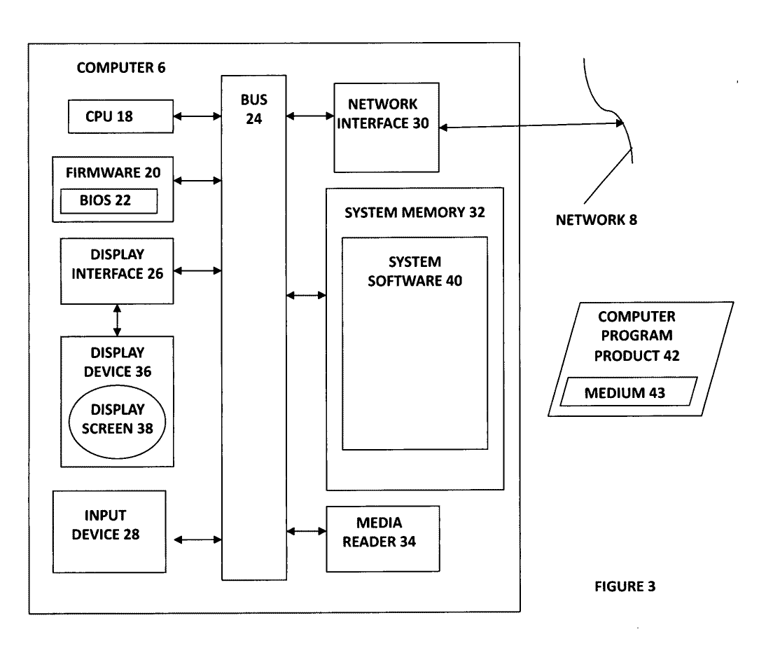

Referring now generally to the Figures and particularly to FIG. 3, FIG. 3 is a schematic diagram of the computer 6.

The computer 6 may be or comprise an electronic computer system, an information appliance configured for Internet-enabled communication, a television set-top box, and/or a wireless communications capable communications device, such as, (a.) a wireless communications enabled SUN SPARCSERVER™ computer workstation marketed by Sun Microsystems of Santa Clara, Calif. running LINUX™ or UNIX™ operating system; (b.) a wireless communications enabled personal computer configured for running WINDOWS XP™, VISTA™ or WINDOWS 7™ operating system marketed by Microsoft Corporation of Redmond, Wash.; (c.) a VAIO FS8900™ notebook computer marketed by Sony Corporation of America, of New York City, N.Y. (d.) a PowerBook G4™ personal computer as marketed by Apple Computer of Cupertino, Calif.; (e.) an iPhone™ cellular telephone as marketed by Apple Computer of Cupertino, Calif.; or (f.) a personal digital assistant enabled for networked communications with the network 8.

The computer 6 includes a central processing unit 18, or “CPU” 18 and a firmware 20. The firmware 20 further includes a set of software-encoded instructions comprising a basic input output system 22, or “BIOS” 22, used to boot-up the computer 6. A communications bus 24 bi-directionally communicatively couples the CPU 18, the firmware 20, a display interface 26, an input device 28, a network interface 30, a system memory 32, and a media reader 34. The display interface 26 bi-directionally communicatively couples a display device 36 comprising a display screen 38 with the communications bus 24. The network interface 30 bi-directionally communicatively couples the electronics communications bus 24 and the electronics communications network 8.

The system memory 32 is a random only access memory wherein system software 40 is maintained and optionally edited or modified by deletion, addition or updating of software encoded instructions.

The media reader 34 is configured to read, and optionally write, machine readable, computer executable software encoded instructions from the computer program product 42. The media writer/reader 34 and the associated computer program product 42 are selected and configure to provide non-volatile storage for the computer 6. Although the description of computer program product 42 contained herein refers to a mass storage device, such as a hard disk or CD-ROM drive, it should be appreciated by those skilled in the art that computer operable 42 can be any available media that can be accessed by the computer 6.

By way of example, and not limitation, computer program product 42 may be or A comprise computer operable storage medium 43 and communication media. Computer operable storage media 43 includes volatile and non-volatile, removable and non-removable media implemented in any method or technology for storage of information such as computer-readable instructions, data structures, program modules or other data. Computer operable storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 6.

The computer program product 42 may comprise machine-readable instructions within a computer operable storage medium 43 which when executed by the computer 6 to cause the computer 6 to perform one or more steps as described in the Figures and enabled by the present disclosure, and/or generate, update, maintain and apply one or more data structures, e.g., indexes 2 or the new index 12.

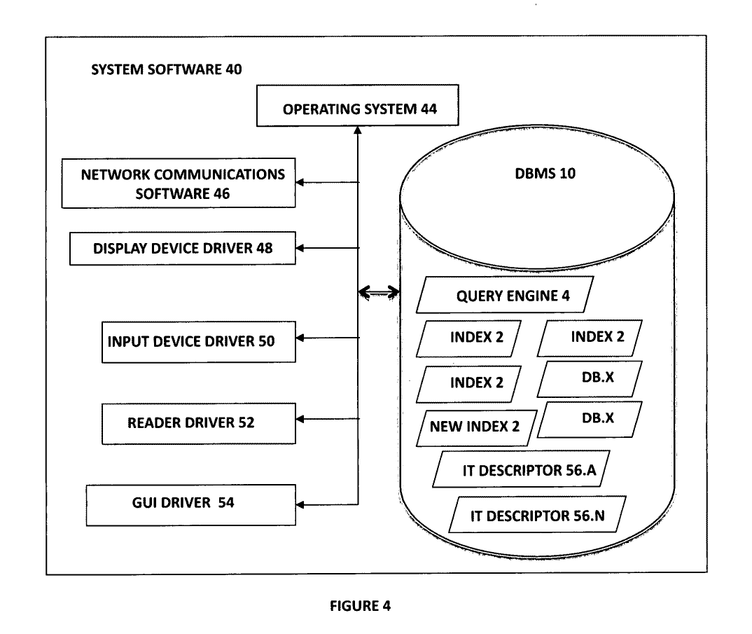

Referring now generally to the Figures and particularly to FIG. 4, FIG. 4 is a schematic diagram of the system software 40 of the computer 6. An operating system 44 that acts as a control layer between the hardware elements of the computer 6 and the software of the computer 6. A network communications software 46 enables the network interface 30 to bi-directionally couple the electronic communications network 8 with the communications bus 24 and the CPU 18. A display device driver 48 enables the CPU 18 to direct the state of the display screen 38 to include the rendering of the menu images. An input driver 50 enables the CPU 18 to accept, execute and interpret commands, instructions, data and selections from the input device 28. A reader driver 52 enables the CPU 18 to accept, execute and interpret software encoded programs, commands, instructions, data and selections from the computer program product 42.

A graphical user interface driver 54, or “GUI” 54, enables the computer 6 to visually render data, e.g., to render the desktop and enables the computer to execute, instantiate, apply, or perform one or more aspects of the processes and data structures of FIGS. 1 through 8.

The system software 40 further includes the DBMS 10, the query engine 4, the indexes 2 and the new index 12.

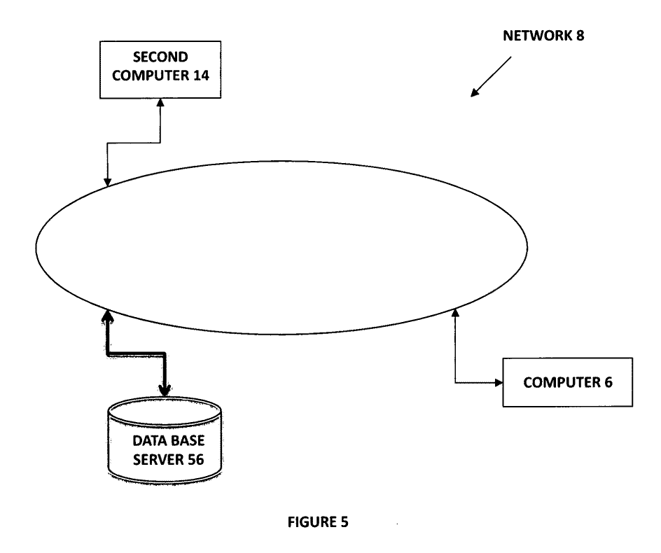

Referring now generally to the Figures and particularly to FIG. 5, FIG. 5 is a schematic diagram of the electronics communications network 8. The electronics communications network 8 may be or comprise the Internet, a computer network, a telephony network, a wireless communications network and/or a wireless telephone network. The second computer 14 and/or a data base server 56 may include one or more data bases DB.1-DB.N and indexes 2 or 12 that may be accessed, or downloaded, via the network 8 by the computer 6.

The second computer 14 and/or the data base server 56 may be or comprise an electronic computer system configured for bi-directional communications with the network 8, such as (a.) a SUN SPARCSERVER™ computer workstation marketed by Sun Microsystems of Santa Clara, Calif. running LINUX™ or UNIX™ operating system; (b.) a server or personal computer configured for running WINDOWS XP™ or VISTA™ operating system marketed by Microsoft Corporation of Redmond, Wash.; (c.) a PowerBook G4™ personal computer as marketed by Apple Computer of Cupertino, Calif.; and (d.) an information appliance configured for Internet-enabled communication.

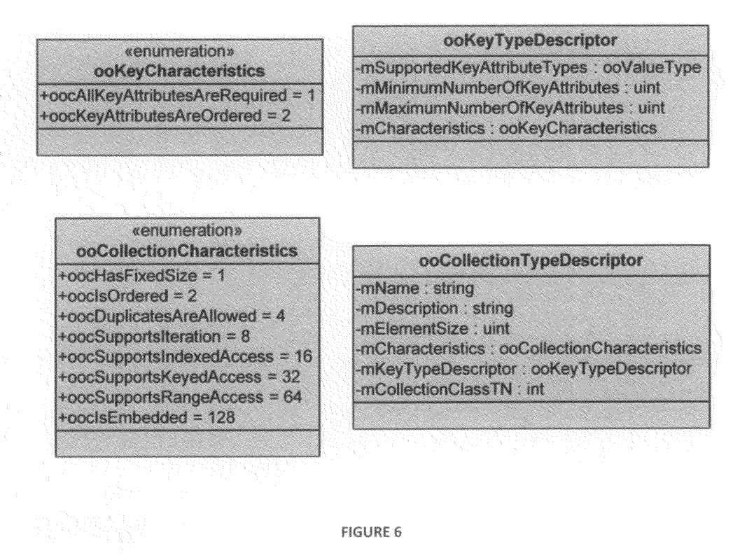

Referring now generally to the Figures and particularly to FIG. 6, FIG. 6 is an illustration of a variety of qualities of an index 2 & 12 that may be denoted within an index type descriptor 56-.A-56.N. In particular, referring to an exemplary first index type descriptor 56.A, two qualities of an index key may be denoted by (1.) a first key bit to indicate whether all key attributes are required in order to apply an example index 56.A; and (2.) a second key bit to indicate that all key attributes ordered or not ordered.

A key type descriptor of the first index type descriptor 56.A may include information indicating (1.) value types of a key that are supported by the first index type descriptor 56.A; (2.) a minimum number of key attributes; (3.) a maximum number of key attributes; and (4.) supported key characteristics.

A collection characteristics data field of the first index type descriptor 56.A may include (1.) a first collection characteristic bit that denotes whether an index 2 & 12 described by the first index type descriptor 56.A has a fixed size; (2.) a second collection characteristic bit that denotes whether an index 2 & 12 described by the first index type descriptor 56.A is ordered; (3.) a third collection characteristic bit that denotes whether an index 2 & 12 described by the first index type descriptor 56.A allows duplicates; (4.) a fourth collection characteristic bit that denotes whether an index 2 & 12 described by the first index type descriptor 56.A supports iteration; (5.) a fifth collection characteristic bit that denotes whether an index 2 & 12 described by the first index type descriptor 56.A supports indexed access; (6.) a sixth collection characteristic bit that denotes whether an index 2 & 12 described by the first index type descriptor 56.A supports keyed access; (7.) a seventh collection characteristic bit that denotes whether an index 2 & 12 described by the first index type descriptor 56.A supports range access; and (4.) an eighth collection characteristic bit that denotes whether an index 2 & 12 described by the first index type descriptor 56.A is embedded.

A collection type descriptor region of the first index type descriptor 56.A may include (1.) a name of the first index type descriptor 56.A as a string value; (2.) a description of the first index type descriptor 56.A as a string value; (3.) an element size as a whole number value; (4.) the collection characteristics data field; (5.) the key type descriptor as two or more binary values; and (6.) a collection class identifier TN as an integer value.

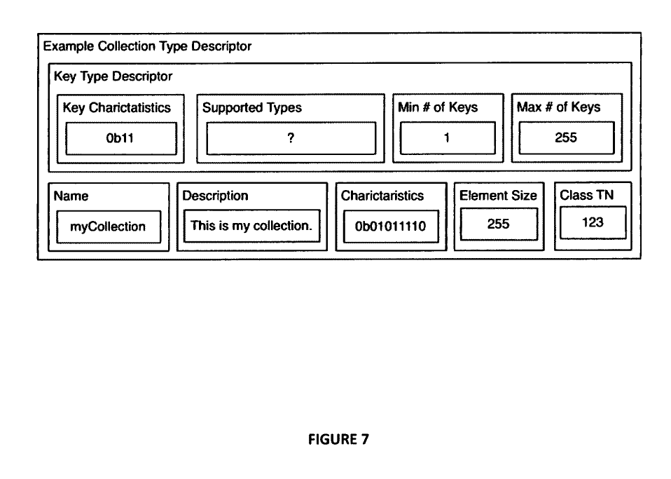

Referring now generally to the Figures and particularly to FIG. 7, FIG. 7 describes an index descriptor 56.A-56.N organized and populated according to a first aspect of the method of the present invention, wherein an index 2 and 12 may be characterized or described using a persistent data structure such as an index type descriptor 56.A-56.N. Optionally or additionally, one or more qualities of an index 2 & 12 that relate to the relevancy of the referenced index 2 & 12 to a particular search process may described using a persistent data structure called an index type descriptor 56.A-56.N that is associated with one or more indexes 2 & 12.

The index type descriptor 56.A-56.N may contain one or more data fields that denote to the DBMS 10 capabilities that are provided by, or are supported by, the referenced index(es) 2 & 12 whereby the query engine 4 can determine how to better utilize instances of the referenced index(es) 2 & 12.

The example first collection index type descriptor 54.A is a software object that allows the query engine 4 to interface with each index 2 & 12 that the first index type descriptor 54.A represents. The first index type descriptor 54.A include a name identifier, a description, a class TN, an element size, a key type descriptor, and a set of characteristics. The name identifier and description may be or include human-readable notations. The class TN may be a machine-readable identifier that uniquely identifies the first index type descriptor 54.A to the DBMS 10. The element size informs the query engine 4 of the size of the element(s) present in the first index type descriptor 54.A. In the case of the first index type descriptor 54.A, the element size is set to 255. The index type characteristics tell the query engine 4 which features are enabled for indexes 2 & 12 of the type described by the first index type descriptor 54.A. In the exemplary first index type descriptor 54.A the collection type characteristics are as follows: (a.) fixed size: false; (b.) ordered: true; (c.) duplicates allowed: false; (d.) supports iteration: true; (e.) supports indexed access: true; (f.) supports keyed access: true; (g.) supports range access: true; and (h.) embedded: false.

The key type descriptor is examined by the DBMS 10, and optionally the query engine 4, to evaluate the key of the first index type descriptor 54.A for collections of the index type described by the first index type descriptor 54.A. There may be four elements of information that the first index type descriptor 54.A provides concerning a key of an associated index 2 & 12: (a.) key characteristics, (b.) supported key types, (c.) a minimum number of key attributes; and (d.) a maximum number of key attributes. These key type characteristics have consequences to the query engine 4 much like the collection type characteristics. In the case of first index type descriptor 54.A, keys of this index type are both required and ordered.

Certain data fields of each index type descriptor 56.A-56.N may allow for describing indexes 2 & 12 that (a.) are not based on object values, e.g., a list data structure and a set of vector parameters; (b.) include a single object value, e.g., a string map; (c.) include multiple compound values, e.g., as a binary tree data structure, optionally with composite key capability; (d.) on multiple independent values, e.g., a multidimensional index; (e.) that support range based lookup, e.g., a binary tree; and/or (f.) do not support a range based lookup, e.g., a hash map.

One or more index type descriptors 56.A-56.N may map to an index type and/or to a specific schema class, and optionally to specific attributes of that class if the index type supports the specific attributes.

Indexes 2 & 12 may be registered at, or associated with, identifiable storage scopes, e.g., one or more (a.) identifiable data bases, (b.) portions of a data base, (c.) federated data bases comprising multiple data bases, and/or (d.) containers of objects or records. A storage scope may, when associated with an index, enable the query engine 4 to determine the suitability or availability for use of the storage scope to optimize a search process within a given scope. Each index descriptor 56.A-56.N may be given a unique identifier, which may be recorded as part of an index registration for an index 2 & 12 so that the DBMS 10 can lookup the index type descriptor 56.A-56.N associated with an index 2 & 12 and examine the nature of each registered index 2 & 12 and then select and use indexes 2 & 12 that are appropriate, or more appropriate, to a given search process.

According to a second aspect of the method of the present invention, the DBMS 10 may select an index 2 & 12 for use at a given scope based on the following algorithm:

(1.) Those indexes 2 & 12 whose associated index type descriptor specifies a class that is not the class scope of the query or a direct or indirect base of that class are removed from consideration. The result of this removal of irrelevant indexes 2 & 12 is a population of a consideration list by the DBMS 10 that includes identifiers of one or more indexes 2 & 12.

(2.) If the predicate is empty:
The index @ & 12 whose index type descriptor 56.A-56.N specifies a class that is the class or is the closest base to the class (close in terms of number of levels of inheritance) is chosen. If two or more indexes 2 & 12 match using this test, the first index 2 & 12 referred to in the consideration list is chosen by the DBMS 10.

(3.) Else:
(a.) Every term in the predicate is evaluated as follows, such that the best fitting index 2 & 12 in any term is selected:
   If there are multiple distinct persistent value comparisons and-ed together:
      The multiple independent value index 2 & 12 referenced in the consideration list that satisfies the most distinct persistent value comparisons while satisfying at least two of them is chosen, if any such indexes 2 & 12 are referenced in the consideration list. If two or more indexes 2 & 12 match using this test, the first index 2 & 12 referred to in the consideration list is chosen by the DBMS 10.
         If no multiple independent value index 2 & 12 is chosen then:
         The multiple compound value index 2 & 12 in the consideration list whose beginning attributes satisfy the most distinct persistent value comparisons in any order in the term is chosen by the DBMS 10, if any. If two or more indexes match using this test, the first index 2 & 12 referred to in the consideration list is chosen by the DBMS 10.
         If no multiple compound value index is chosen then:
         Between single value index indexes in the consideration list who satisfy a single value comparison, the index descriptor that specifies a class that is the class or is the closest base to the class (close in terms of number of levels of inheritance) is chosen by the DBMS 10, if any such indexes 2 & 12 are referenced in the consideration list. If two or more indexes match using this test, the first index 2 & 12 referenced in the consideration list is chosen by the DBMS 10.
   (b.) If no index 2 & 12 has been chosen by the DBMS 10, then the index 2 & 12 is chosen by the DBMS 10 as if the predicate were empty.

According to yet another alternate aspect of the method of the present invention, the DBMS may require that in order for an index 2 & 12 to be applied or used by the query engine 4, wherein each index 2 & 12 must be determined to implement all pure virtual methods in an abstract base class, e.g., Index: C++ software programming, or implement an interface, e.g., IIndex: Java, C# software programming languages.

Various alternate aspects of the method of the present invention optionally, alternatively or additionally support looking up a single item, applying an iterator for a range of items, and updating the index.

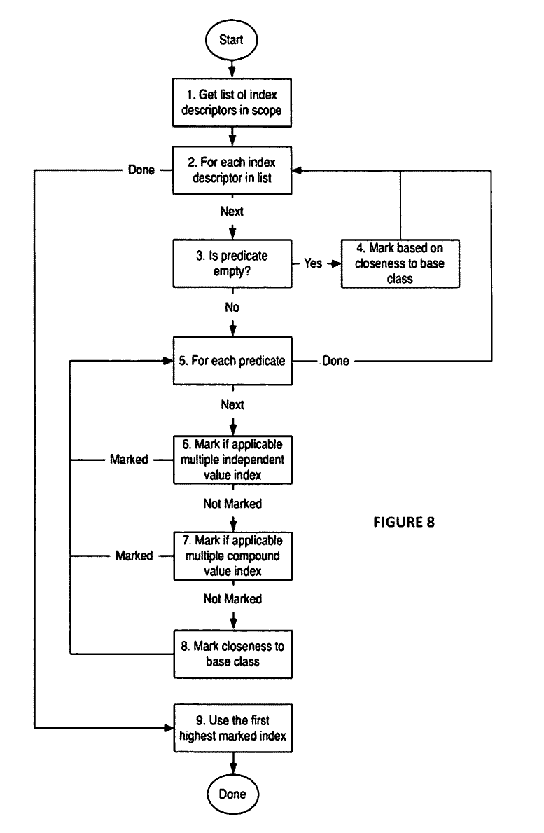

Referring now generally to the Figures and particularly to FIG. 8, FIG. 8 illustrates a third aspect of the method of the present invention, wherein the DBMS 10 examines, selects and applies at least one index 2 and 12 for selection for use in handling separate search processes.

In step 1, a list of all index type descriptors 56.A-56.N is fetched from a persistent collection which the DBMS 10 maintains. Those indexes 2 & 12 that are within the scope of each index type descriptor 56.A-56.N referenced by the consideration list is iterated though in step 2 by the DBMS 10, wherein a best matching index 1 & 12 is sought by the DBMS 10. During this loop, each index type descriptor 56.A-56.N is marked with a score and the consideration list is kept ordered by this relevancy score in a priority queue.

The DBMS determines in step 3 whether the predicate of a query of the instant search process is empty. If the DBMS 10 determines that the instant predicate is empty, the DBMS 10 proceeds from step 3 to step 4, and if the DBMS 10 determines that the instant predicate is not empty, the DBMS 10 proceeds from step 3 to step 5.

In step 4, the DBMS 10 evaluates and assigns a score to each examined index type descriptor based on a measure of relevancy to the base class in terms of inheritance hierarchy. The DBMS 10 may loop from step 4 to step 2 until each index type descriptor 56.A-56.N referenced in the consideration list has been processed.

Alternatively, in step 5, the DBMS iterates through each predicate in the instant query. It is understood that the term “predicate” as used in this disclosure refers to a part of a search query which may affect the usefulness of using an index 2 & 12.

In step 6, the DBMS 10 determines and marks each examined index type descriptor 56.A-56.N to indicate whether the examined index type descriptor 56.A-56.N is a multiple independent value index which satisfies at least 2 predicates. The DBMS 10 thereby compares information stored in each examined index type descriptor 56.A-56.N to evaluate and score a relevancy to the instant search query.

In step 7, the DBMS 10 determines and marks each examined index type descriptor 56.A-56.N to indicate whether the examined index type descriptor 56.A-56.N is a multiple compound value index which satisfies the most distinct persistent value comparison, i.e., the DBMS 10 compares information stored in the examined index type descriptor 56.A-56.N to the instant search query

In step 8, the DBMS determines and marks a degree of closeness of an examined index type descriptor 56.A-56.N as referenced within the consideration list.

Once all the indexes 2 & 12 referenced in the consideration list have been examined in looping through steps 2 through 8, the DBMS 10 in step 9 chooses a first and highest ranking index type descriptor 56.A-56.N, and optionally one or more additional examined and scores index type descriptors 56.A-56.N in order of declining relevancy score, to be used in handling the instant search query.

The foregoing disclosures and statements are illustrative only of the present invention, and are not intended to limit or define the scope of the present invention. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

What is claimed is:

1. A method for directing a computer having a database management system to apply a user provided index, the method comprising:
a. Providing an index to the computer;
b. Providing an index descriptor of the index to the computer, the index descriptor authored at least in part by a programmer and indicating a quality of the index;
c. Directing the database management system to perform the search; and
d. Directing the database management system to evaluate a relevance of the index to the search.

2. The method of claim 1, wherein the database management system further comprises a plurality of indexes, and the method further comprises directing the computer to apply the index descriptor to determine a relevance of the user provided index relative to the plurality of indexes.

3. The method of claim 2, further comprising applying a sequence of indexes in performing the search, wherein the user provided index is ordered within the sequence of indexes on the basis of the relevance of the user provided index to the search.

4. The method of claim 1, wherein the index descriptor indicates that all key attributes are required by the computer to apply the user provided index in the search.

5. The method of claim 1, wherein the index descriptor indicates a key attribute of the user provided index.

6. The method of claim 1, wherein the index descriptor indicates a key attribute.

7. The method of claim 1, wherein the index descriptor indicates that a plurality of key attributes of the user provided index are ordered.

8. The method of claim 1, wherein the index descriptor indicates a collection characteristic.

9. The method of claim 8, wherein the collection characteristic specifies that a collection is ordered.

10. The method of claim 8, wherein the collection characteristic specifies that duplicate records are allowed.

11. The method of claim 8, wherein the collection characteristic specifies that the user provided index supports search iteration.

12. The method of claim 8, wherein the collection characteristic specifies that the user provided index supports keyed access.

13. The method of claim 8, wherein the collection characteristic specifies that the user provided index supports range access.

14. The method of claim 1, wherein the index descriptor includes a collection type descriptor.

15. The method of claim 14, wherein the collection type descriptor includes a collection characteristic.

16. The method of claim 14, wherein the collection type descriptor is a key type descriptor.

17. The method of claim 14, wherein the collection type descriptor includes a collection class identifier.

18. An information technology system comprising:
one or more processors;
an input device enabling a user to provide data to at least one processor;
a memory accessible by the at least one of the one or more processors;
a display module configured to visually display information received from the memory or the at least one network interface;
a process operated by the one or more processors to manage software program selection, the process being effective to:
a. accept a user provided index;
b. accept an index descriptor from the input device, the index descriptor authored at least in part by a programmer;
c. accepting a search command from the input device;
d. forming a search query from the search command; and
e. evaluating the index descriptor to determine a relevance of the user provided index to the search.

19. The information technology system of claim 18, wherein the information technology further comprises an electronic media reader, and wherein the process is effective to read the user provided index from an electronic medium.

20. A computer program product comprising:
a computer operable storage medium having computer readable code, the computer readable code being effective to:
a. accept a user provided index;
b. accept an index descriptor from the input device, the index descriptor authored at least in part by a programmer;
c. accepting a search command from the input device;
d. forming a search query from the search command; and
e. evaluating the index descriptor to determine a relevance of the user provided index to the search.
